(19) United States
(12) Patent Application Publication
(10) Pub. No.: US 2025/0095263 A1
(43) Pub. Date: Mar. 20, 2025

(54) INFORMATION PROCESSING SYSTEM, INFORMATION PROCESSING METHOD, AND COMPUTER-READABLE NON-TRANSITORY STORAGE MEDIUM

(71) Applicant: SONY GROUP CORPORATION, TOKYO (JP)

(72) Inventor: HISASHI KOBIKI, TOKYO (JP)

(21) Appl. No.: 18/729,364

(22) PCT Filed: Jan. 10, 2023
(86) PCT No.: PCT/JP2023/000255

§ 371 Date: Jul. 16, 2024

(30) Foreign Application Priority Data
Jan. 25, 2022 (JP) 2022-009184

(51) Int. Cl. G06T 15/00

(52) U.S. Cl. CPC G06T 15/00

(57) ABSTRACT

An information processing system (1) includes a base coefficient learning unit (12) and a map coefficient learning unit (13). The base coefficient learning unit (12) learns a base coefficient (BC) by using a plurality of image data sets (DS) including a first image data set corresponding to a first scene and a second image data set corresponding to a second scene. The map coefficient learning unit (13) transfers a learning result of the base coefficient (BC) and performs transfer learning of a first map coefficient based on the first image data set. The map coefficient learning unit (13) transfers the learning result of the base coefficient (BC) and performs transfer learning of a second map coefficient based on the second image data set.

### FIELD

The present invention relates to an information processing system, an information processing method, and a computer-readable non-transitory storage medium.

### BACKGROUND

Computer Graphics (CG) rendering requires a large-scale rendering operation such as ray tracing. For example, in a game in which a quest is performed in a virtual space viewed from a virtual viewpoint, it is necessary to render a virtual viewpoint image in real time. Thus, there is a trade-off between high definition and a real-time property.

On the other hand, a technique which is called “denoiser” and in which an image rendered by a small number of rendering operations (rendered image) is corrected by image processing is known. By using the denoiser, it is possible to shorten rendering time and output a high-definition virtual viewpoint image in real time.

### CITATION LIST

### Patent Literature

Patent Literature 1: Japanese Patent Application Laid-open No. 2021-86272

### Non Patent Literature

Non Patent Literature 1: X. Wang et. aQ019, Deep Network Interpolation for Continuous Imagery Effect Transition

### SUMMARY

### Technical Problem

In the denoiser, nonlinear and complicated image processing is required. Thus, in recent years, denoising is often performed by utilization of a deep neural network. In order to realize the high-speed denoiser, it is conceivable to use a neural network having a small size (small network). However, in the small network, it is difficult to secure sufficient generalization performance for various maps having different scenes.

Thus, it is conceivable to optimize a large number of parameters included in the small network (hereinafter, these parameters are collectively referred to as a “coefficient”. The “coefficient” is a generic name of a parameter group a value of which is determined by machine learning) for each map, and to switch and use a plurality of optimized small networks according to a position of a virtual viewpoint. However, in a case where the virtual viewpoint seamlessly moves from a first map to a second map, when a coefficient of the small network discontinuously switches from a coefficient corresponding to the first map (first map coefficient) to a coefficient corresponding to the second map (second map coefficient) at a boundary of the maps, image quality of a displayed video may be deteriorated.

On the other hand, it is conceivable to secure image quality of the both maps by calculating an intermediate coefficient between the first map coefficient and the second map coefficient by interpolation processing. For example, Non-Patent Literature 1 describes a method of continuously changing an output image by linearly interpolating coefficients of a learned neural network in a parameter space. Patent Literature 1 describes a method of adjusting image quality by obtaining data between two coefficients learned with a change in processing intensity by interpolation processing in a neural network that performs sharpness improvement and blur removal processing.

In both of the above-described two methods, interpolation processing is performed on two coefficients learned from two corresponding learning data sets. “Corresponding” means that scenes drawn in image groups of the learning data sets are equal in the two learning data sets. In this method, a large deviation is not generated between the two learned coefficients.

However, when similar interpolation processing is performed on two coefficients learned from two learning data sets respectively corresponding to different scenes, a large deviation is generated between the two learned coefficients. Thus, an appropriate coefficient cannot be obtained by the interpolation processing. Thus, even when a coefficient optimized for each map is acquired, appropriate image processing is not performed by interpolation processing similar to that of a related art.

Thus, the present disclosure proposes an information processing system, an information processing method, and a non-transitory storage medium capable of performing seamless image processing between maps.

### Solution to Problem

According to the present disclosure, an information processing system is provided that comprises: a base coefficient learning unit that performs learning of a base coefficient by using a plurality of image data sets including a first image data set corresponding to a first scene and a second image data set corresponding to a second scene; and a map coefficient learning unit that acquires a first map coefficient corresponding to the first scene by transfer learning of transferring the base coefficient on a basis of the first image data set and acquires a second map coefficient corresponding to the second scene by transfer learning of transferring the base coefficient on a basis of the second image data set. According to the present disclosure, an information processing method in which an information process of the information processing system is executed by a computer, and a computer-readable non-transitory storage medium which stores a program for causing the computer to execute the information process of the information processing system, are provided.

### BRIEF DESCRIPTION OF DRAWINGS

FIG. 1 is a diagram illustrating a schematic configuration of a learning system.

FIG. 2 is a diagram for describing a learning method.

FIG. 3 is a diagram for describing the learning method.

FIG. 4 is a diagram for describing a difference from a general learning method (first comparative example).

FIG. 5 is a diagram for describing a difference from a method disclosed in a related art (second comparative example).

FIG. 6 is a diagram illustrating an example of a processing flow of the learning system.

FIG. 7 is a diagram illustrating a schematic configuration of a rendering system.

FIG. 8 is a diagram for describing a specific example of rendering using a plurality of maps.

FIG. 9 is a diagram illustrating an example of a processing flow of the rendering system.

FIG. 10 is a diagram for describing another example of rendering using a plurality of maps.

FIG. 11 is a diagram illustrating an example of a hardware configuration of an information processing system.

### DESCRIPTION OF EMBODIMENTS

In the following, embodiments of the present disclosure will be described in detail on the basis of the drawings. In each of the following embodiments, overlapped description is omitted by assignment of the same reference sign to the same parts.

Note that the description will be made in the following order.
[1. Learning system]
   [1-1. System configuration example]
   [1-2. Learning method]
[2. Rendering system]
   [2-1. System configuration example]
   [2-2. Specific example of rendering]
   [2-3. Processing flow]
   [2-4. Another example of rendering]
[3. Hardware configuration example]
[4. Effect]
[5. Modification example]

### 1. LEARNING SYSTEM

### 1-1. System Configuration Example

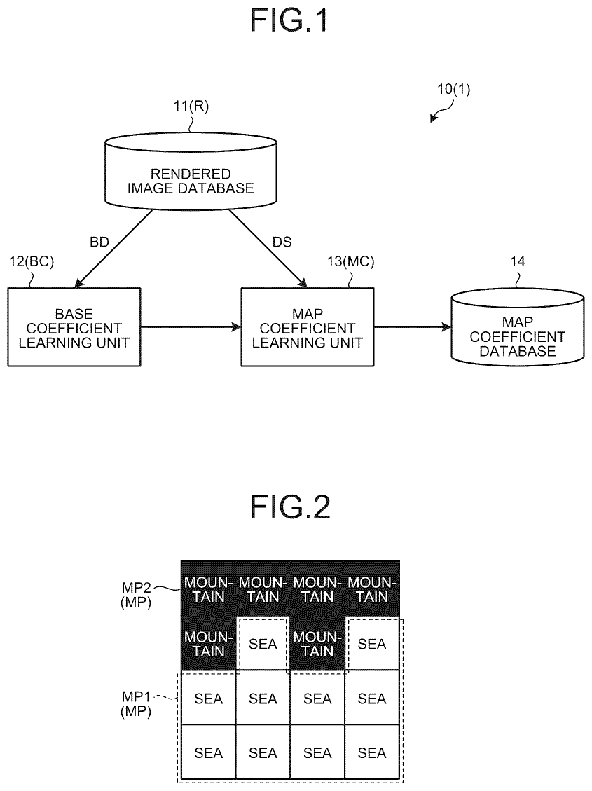

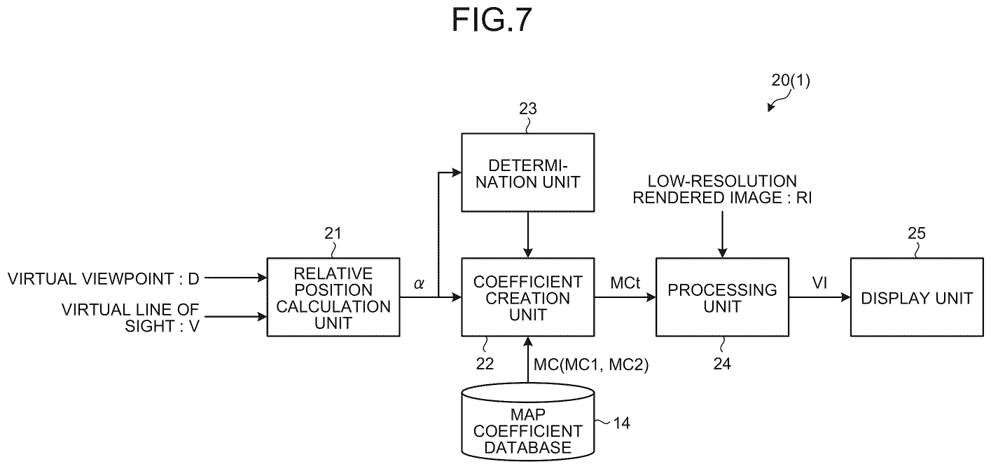

Hereinafter, an information processing system 1 of the present disclosure will be described on the basis of the drawings. The information processing system 1 includes a learning system 10 and a rendering system 20 (see FIG. 7). FIG. 1 is a diagram illustrating a schematic configuration of the learning system 10.

The learning system 10 includes a rendered image database 11, a base coefficient learning unit 12, a map coefficient learning unit 13, and a map coefficient database 14.

The rendered image database 11 stores a rendered image group R for machine learning. The rendered image group R includes a large number of rendered images obtained by rendering of various scenes from various virtually set viewpoints (virtual viewpoints). Rendering means processing of reproducing a landscape or an object described by a 3D model as a 2D image viewed from the virtual viewpoint. The rendered image may be an image of a real world or an image of a virtual space such as a 3DCG game or virtual reality (VR). In the present disclosure, a sight in a virtual space is used as a rendered image.

For example, in a case of a 3DCG game in which a quest is performed in the virtual space from a first-person view, a rendered image group in which virtual scenes such as the sea and mountain or virtual objects such as a rock and grass are observed from a viewpoint of a main character is a target. In the game, a plurality of maps MP having different scenes (see FIG. 2) is prepared. For example, in a game in which a plurality of stages is to be cleared, a map MP is prepared for each of the stages. In a case where landscapes (such as sea, mountain, streets, and jungle) greatly change depending on a destination even in the same stage, a map MP is prepared for each of the landscapes. An aspect of a subject varies depending on the target map MP.

The base coefficient learning unit 12 learns a base coefficient BC by using the rendered image group R. The coefficient means a parameter held by a learning-type model such as a deep neural network. In the present disclosure, a large number of parameters included in the learning-type model are collectively referred to as a “coefficient”. The base coefficient BC is applied to a neural network for enhancing resolution (denoising) of a low-resolution rendered image. In general, a deep neural network for image processing realizes various kinds of image processing such as resolution enhancement and noise removal by performing prediction processing by using a coefficient learned by a predetermined learning scheme. The base coefficient learning unit 12 creates a basic data set BD by using the rendered image group R, and learns the base coefficient BC by using the basic data set BD.

The basic data set BD comprehensively includes images of various scenes included in all the maps MP. For example, the base coefficient learning unit 12 selects a plurality of rendered images having various different rendering conditions (such as specific scene attributes such as the sea and the mountain, a position of a virtual viewpoint in the scene, and a sight direction in which the scene is visually recognized) from the rendered image group R. The base coefficient learning unit 12 generates a pair of rendered images having different resolutions (image pair) for each selected rendered image on the basis of a selected rendering condition.

A low-resolution rendered image included in the image pair is input data for machine learning. A high-resolution rendered image included in the image pair is correct data for machine learning. The low-resolution rendered image is generated, for example, by deterioration of resolution of the high-resolution rendered image. However, a method of generating the low-resolution rendered image is not limited to the above. The low-resolution rendered image may be generated by re-rendering with conditions other than the resolution being made equal to those at the time of generation of the high-resolution rendered image.

The basic data set BD includes a plurality of image pairs corresponding to various scenes. Each of the image pairs is associated with any one of the maps MP. A plurality of image pairs corresponding to the same map MP is included in one image data set DS. The basic data set BD includes a plurality of the image data sets DS corresponding to different maps MP (scenes). The base coefficient learning unit 12 learns the base coefficient BC by using the plurality of image data sets DS included in the basic data set BD. For example, the base coefficient learning unit 12 learns the base coefficient BC by optimizing a regression task using the basic data set BD with the deep neural network.

As a learning method of the base coefficient BC, a general deep neural network learning method can be employed. For example, first, the base coefficient learning unit 12 inputs, to the deep neural network, a low-resolution rendered image group in the basic data set BD as an input image group and a high-resolution rendered image group as a correct image group. Next, the base coefficient learning unit 12 sets a regression problem of a two-dimensional waveform predicting a high-resolution image group from the input image group. Next, the base coefficient learning unit 12 calculates a square error of a difference in gradation values between a predicted image group predicted from the input image group and the correct image group as loss, and optimizes the coefficient by a sequential update method such as a steepest descent method.

By learning with utilization of the basic data set BD, the base coefficient BC capable of corresponding to various scenes are generated. The base coefficient BC is a coefficient of a general-purpose neural network that can be generally applied to all the maps MP. The general-purpose neural network is configured as a neural network having a small size (small network) in order to realize a high-speed denoiser. However, in the small network, it is not possible to secure sufficient generalization performance for various maps MP having different scenes. Thus, the map coefficient learning unit 13 learns a dedicated neural network for each of the maps MP by transfer learning in which a learning result of the general-purpose neural network is transferred.

The map coefficient learning unit 13 transfers the learning result of the base coefficient BC and performs, for each of the maps MP, transfer learning of the map coefficient MC in which learning the image data set DS corresponding to the map MP is used. The map coefficient MC is a coefficient of a dedicated neural network exclusively applied to only one map MP. The learned map coefficient MC is stored in the map coefficient database 14.

In the present disclosure, for example, a use in which a quest is seamlessly performed in the first-person view from the virtual viewpoint in the virtual scenes such as the sea and mountain existing in the virtual space is assumed. The virtual scenes such as the sea and mountain are localized in the virtual space. When rendering is performed at the time of entrance of the virtual viewpoint into a space in which the scene exists, the scene is output as a 2D image.

In the present disclosure, geometry information of a virtual space corresponding to each scene is called the map MP. The geometry information includes information related to a range and terrain of a landscape, and information related to an object shape, a localization state, and the like. A subject in a rendered image obtained when the virtual viewpoint enters a specific map MP is similar in each map MP. Conversely, when the maps MP are different, the subject in the rendered image is in greatly different states. Thus, learning of the map coefficient MC is performed by utilization only of the image data set DS of the corresponding map MP.

### 1-2. Learning Method

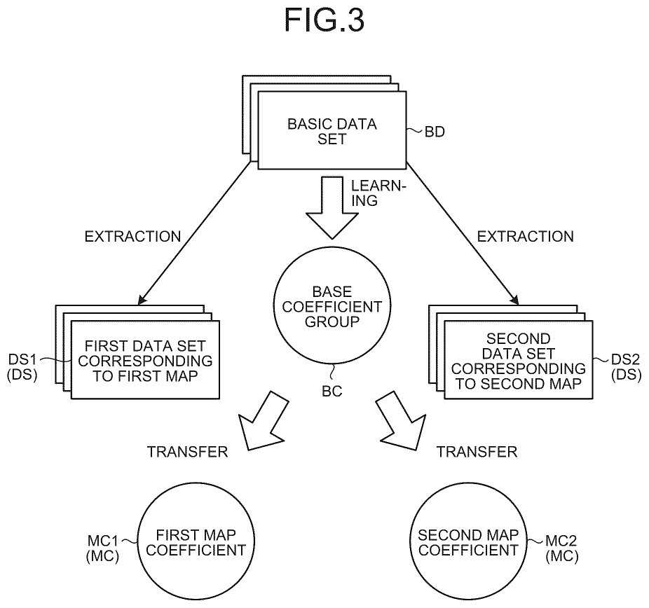

FIG. 2 and FIG. 3 are diagrams for describing the learning method.

In the examples of FIG. 2 and FIG. 3, a first map MP1 corresponding to a first scene and a second map MP2 corresponding to a second scene are presented as the maps MP. The first scene is, for example, a scene of the “mountain”. The second scene is a scene of the “sea”. The base coefficient learning unit 12 learns the base coefficient BC by using the plurality of image data sets DS included in the basic data set BD. The plurality of image data sets DS includes a first image data set DS1 corresponding to the first map MP1 (first scene) and a second image data set DS2 corresponding to the second map MP2 (second scene).

The map coefficient learning unit 13 extracts the first image data set DS1 and the second image data set DS2 from the basic data set BD. The map coefficient learning unit 13 acquires, as the first image data set DS1, a plurality of image pairs in which the “mountain” is rendered on the basis of various virtual viewpoints. The map coefficient learning unit 13 acquires, as the second image data set DS2, a plurality of image pairs in which the “sea” is rendered on the basis of various virtual viewpoints.

The map coefficient learning unit 13 acquires the first map coefficient MC1 corresponding to the first scene by the transfer learning of transferring the base coefficient BC on the basis of the first image data set DS1. The map coefficient learning unit 13 acquires the second map coefficient MC2 corresponding to the second scene by the transfer learning of transferring the base coefficient BC on the basis of the second image data set DS2.

The transfer learning means a machine learning method in which knowledge learned in a certain region is utilized for another region for effective learning. For example, the map coefficient learning unit 13 learns the first map coefficient MC1 and the second map coefficient MC2 with the base coefficient BC as a start point of the machine learning. Specifically, the map coefficient learning unit 13 sets the base coefficient BC as an initial value of the coefficient and performs learning using an individual image data set DS when a task of performing regression prediction of the high-resolution rendered image from the low-resolution rendered image is optimized by the deep neural network as described above.

The map coefficient learning unit 13 changes at least a part of the initial value (learned base coefficient BC) by the transfer learning. At this time, the map coefficient learning unit 13 can control an update amount according to a depth of the neural network. For example, the map coefficient learning unit 13 changes an intermediate layer close to an output layer of the neural network greatly compared to an intermediate layer close to an input layer thereof by the transfer learning. As a result, the map coefficient learning unit 13 relatively increases the update amount of the coefficient close to the output layer of the neural network.

In general, it has been confirmed that low-order feature amounts such as an edge and a direction are extracted from an input image in a layer far from the output layer, that is, close to the input layer of the deep neural network. Thus, even when the image data set to be learned is changed, stable learning can be performed when the coefficient of the layer close to the input layer is not greatly changed. On the other hand, in the layer close to the output layer of the deep neural network, extraction of high-order features such as a shape and texture is performed. Thus, in a case where the image data set is changed, when the coefficient of the layer close to the output layer is greatly changed, more accurate regression can be performed.

As described above, according to the learning method of the present disclosure, the map coefficient MC optimized for each of the maps MP can be acquired. In general, in a case of regression prediction by the deep neural network, when a size of the network is the same, regression performance becomes ordinary and general as distribution of data to be regressed becomes wider, and the regression performance becomes more specialized in a localized state as the distribution of the data to be regressed is more localized. Thus, in a case where it is necessary to reduce the size of the network in order to improve the real-time property, the map coefficient MC optimized by utilization of the image data set DS localized for each of the maps MP as in the present disclosure is created, and adaptive utilization thereof is performed, whereby the regression performance specialized for each of the maps MP can be presented.

In addition, by learning the map coefficient MC from the base coefficient BC by the transfer learning, it is possible to linearly interpolate the map coefficient MC in a parameter space. As a result, the rendering system 20 (see FIG. 7) described later can adaptively display a high-definition real-time virtual viewpoint image VI for various different map images.

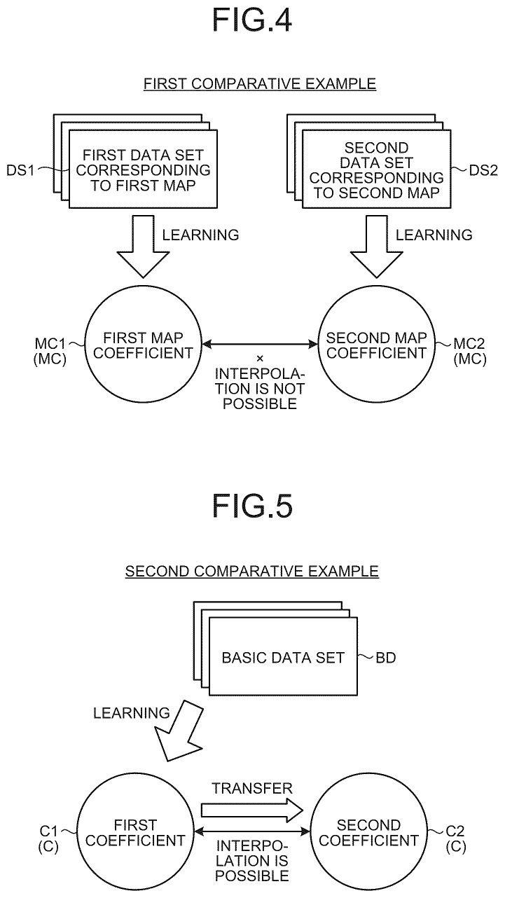

Hereinafter, a difference between the learning method of the present disclosure and a general learning method and a method disclosed in the related art (Patent Literature 1 and a Non-Patent Literature 1) will be described. FIG. 4 is a diagram for describing a difference from the general learning method (first comparative example). FIG. 5 is a diagram for describing a difference from the method disclosed in the related art (second comparative example).

### Comparison With the First Comparative Example

As illustrated in FIG. 4, in the first comparative example, in order to create a map coefficient MC optimized for each map MP, learning of a first map coefficient MC1 and a second map coefficient MC2 is performed by utilization of a first image data set DS1 and a second image data set DS2 without transfer. However, in general, in a case of a deep neural network, when an image data set DS to be learned changes, local similarity is impaired between two learned coefficients. Since interpolation processing cannot be performed between pieces of data having no similarity, an intermediate coefficient between the first map coefficient MC1 and the second map coefficient MC2 cannot be appropriately acquired in a parameter space.

On the other hand, in a case where the transfer learning from the base coefficient BC is performed as in the present disclosure, local similarity between the first map coefficient MC1 and the second map coefficient MC2 is maintained, whereby an intermediate coefficient between the first map coefficient MC1 and the second map coefficient MC2 (intermediate coefficient MCt: see FIG. 7) can be appropriately acquired in the parameter space. Thus, even in a case where the virtual viewpoint seamlessly moves between the first map MP1 and the second map MP2, the intermediate coefficient MCt corresponding to a position of the virtual viewpoint is calculated, whereby the deterioration of the image quality is controlled.

### Comparison With the Second Comparative Example

As illustrated in FIG. 5, in the second comparative example, similarly to the learning method of the present disclosure, learning is performed in such a manner that interpolation processing between coefficients C can be performed by transfer learning. However, a purpose is to adjust image quality, utilization is possible only for a use of “performing linear interpolation with respect to coefficients learned with two corresponding learning data sets (first coefficient C1 and second coefficient C2). Thus, it is not possible to perform the interpolation processing with respect to a plurality of coefficients C learned with map images, which do not correspond to each other, as learning data.

On the other hand, in the learning method of the present disclosure, the interpolation processing can be performed on the plurality of map coefficients MC learned with various map images. Thus, even in a case where the virtual viewpoint seamlessly moves between the first map MP1 and the second map MP2, the suitable intermediate coefficient MCt is calculated according to the position of the virtual viewpoint by the interpolation processing, whereby the deterioration of the image quality is controlled.

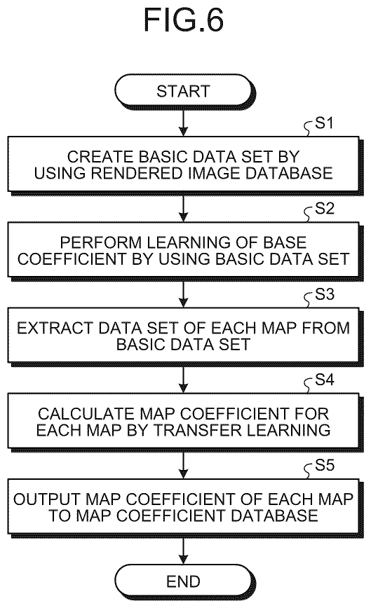

FIG. 6 is a diagram illustrating an example of a processing flow of the learning system 10.

The base coefficient learning unit 12 creates the basic data set BD by using the rendered image database 11 (Step S1). The base coefficient learning unit 12 learns the base coefficient BC by using the basic data set BD (Step S2). The map coefficient learning unit 13 extracts the image data set DS of each map MP from the basic data set BD (Step S3). The map coefficient learning unit 13 performs transfer learning of a map coefficient MC based on a single image data set DS by diverting a learning result of the base coefficient BC (Step S4). The map coefficient learning unit 13 outputs the learned map coefficient MC acquired by the transfer learning to the map coefficient database 14 (Step S5).

### 2. RENDERING SYSTEM

### 2-1. System Configuration Example

FIG. 7 is a diagram illustrating a schematic configuration of the rendering system 20.

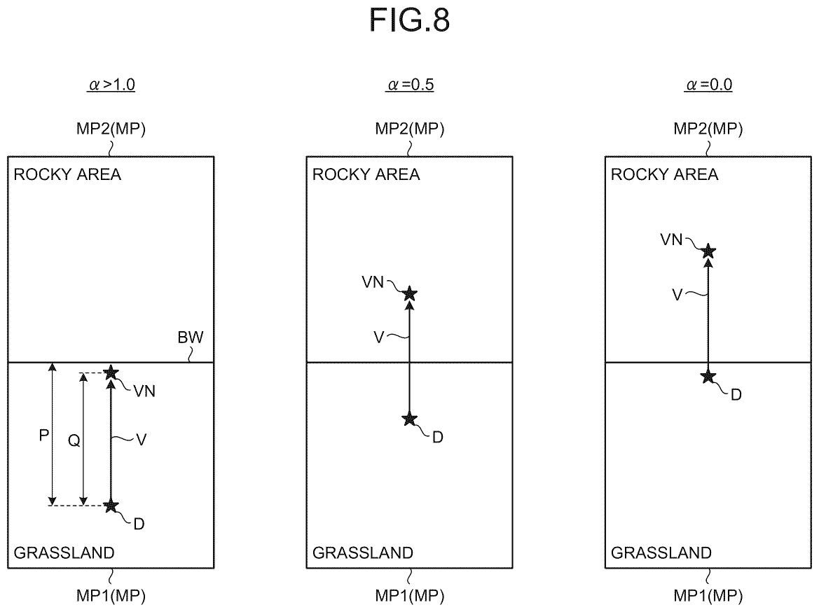

The rendering system 20 performs rendering on the basis of a virtual viewpoint D and a virtual line of sight V. The virtual viewpoint D means a virtual viewpoint in the virtual space. The virtual line of sight V means a virtual line of sight starting from the virtual viewpoint D. The virtual line of sight V is defined as, for example, a vector from the virtual viewpoint D to a vanishing point VN (see FIG. 8).

The rendering system 20 includes a relative position calculation unit 21, a coefficient creation unit 22, a determination unit 23, a processing unit 24, and a display unit 25.

The relative position calculation unit 21 calculates a relative position α between the maps MP. The relative position is calculated, for example, as a ratio of the maps MP appearing in a video (rendered image) viewed from the virtual viewpoint D. The coefficient creation unit 22 calculates an intermediate coefficient of a plurality of the map coefficients MC (intermediate coefficient MCt) by interpolation processing based on the relative position α.

The determination unit 23 determines necessity of the interpolation processing on the basis of the relative position α. For example, in a case where the plurality of maps MP appears in the rendered image, the determination unit 23 determines that the interpolation processing is necessary. In a case where only one map MP appears in the rendered image, the determination unit 23 determines that the interpolation processing is unnecessary.

The processing unit 24 performs image processing of a low-resolution rendered image RI by using the intermediate coefficient MCt obtained by the interpolation processing. In a case where the determination unit 23 determines that the interpolation processing is unnecessary, the processing unit 24 performs the image processing by using the map coefficient MC corresponding to the map MP appearing in the rendered image as it is.

The low-resolution rendered image RI is a rendered image rendered in such a manner that resolution is lower than an image format required for the display unit 25. The processing unit 24 generates a high image quality virtual viewpoint image VI by performing the image processing of the low-resolution rendered image RI. The display unit 25 displays the virtual viewpoint image VI obtained by the image processing on a screen.

### 2-2. Specific Example of Rendering

FIG. 8 is a diagram for describing a specific example of rendering using a plurality of maps MP.

In the example of FIG. 8, the first map MP1 and the second map MP2 are used as the plurality of maps MP. The first map MP1 is a map MP indicating grassland. The second map MP2 is a map MP indicating a rocky area. The relative position calculation unit 21 calculates a relative position α between the first map MP1 and the second map MP2. The relative position calculation unit 21 calculates, as the relative position α, a ratio of the first map MP1 and the second map MP2 appearing in the rendered image.

For example, the relative position α is calculated on the basis of a distance P from the virtual viewpoint D to a boundary BW between the first map MP1 and the second map MP2 and a distance Q from the virtual viewpoint D to the vanishing point VN. When the distance to the boundary BW is P, the distance to the vanishing point VN is Q, and the relative position is α, α=P/Q is satisfied.

In an example on a left side of FIG. 8, since P>Q, α>1.0. In an example at a center of FIG. 8, since the virtual line of sight V is on a half of each of the first map MP1 and the second map MP2, α=0.5. In an example on a right side of FIG. 8, since 90% of the vector indicating the virtual line of sight V is included in the second map MP2, α=0.9.

The determination unit 23 determines necessity of the interpolation processing on the basis of the relative position α. For example, in the example on the left side of FIG. 8, α>1.0. Only the first map MP1 appears in the rendered image. Since it is not necessary to use the map coefficient MC other than that of the first map MP1 (second map coefficient MC2 of the second map MP2), the determination unit 23 determines that the interpolation processing is unnecessary. In the example at the center and the example on the right side of FIG. 8, both the first map MP1 and the second map MP2 appear in the rendered image. Thus, the determination unit 23 determines that the interpolation processing is necessary. In a situation in which the interpolation processing is not necessary, only a specific map coefficient MC is selectively used. Thus, high-speed processing in which the interpolation processing is omitted is performed.

In a situation in which the interpolation processing is necessary, the coefficient creation unit 22 calculates the intermediate coefficient MCt between the first map coefficient MC1 and the second map coefficient MC2 by the interpolation processing based on the relative position α. The processing unit 24 performs the image processing of the low-resolution rendered image RI by using the intermediate coefficient MCt. For example, the intermediate coefficient Wt is calculated as a value satisfying Wt=α×W1+(1−α)×W2 by utilization of the first map coefficient W1 and the second map coefficient W2. The intermediate coefficient Wt is one coefficient included in the intermediate coefficient MCt. The first map coefficient W1 and the second map coefficient W2 are coefficients of the first map coefficient MC1 and the second map coefficient MC2 which coefficients correspond to the intermediate coefficient Wt.

In the example on the left side of FIG. 8, since α>1.0, 100% of the first map coefficient MC1 corresponding to the first map MP1 is employed according to the determination of the determination unit 23. In the example at the center of FIG. 8, since α=0.5, the intermediate coefficient MCt including 50% of each of the first map coefficient MC1 and the second map coefficient MC2 is calculated. In the example on the right side of FIG. 8, since α=0.1, the intermediate coefficient MCt in which the first map coefficient MC1 and the second map coefficient MC2 are included at a ratio of 1:9 is calculated.

The processing unit 24 performs image processing by using the intermediate coefficient MCt and the low-resolution rendered image RI. A deep neural network using the intermediate coefficient MCt (interpolation neural network) is a model that performs regression of a high-resolution rendered image from a low-resolution rendered image. Thus, the high-resolution rendered image can be acquired by application of the intermediate coefficient MCt to the deep neural network and an input of the low-resolution rendered image RI. The acquired high resolution rendered image is presented as a virtual viewpoint image.

In the rendering system 20 described above, the plurality of map coefficients MC is adaptively switched according to the ratio of the maps MP appearing around the virtual line of sight V. When the resolution of the low-resolution rendered image RI is enhanced, a contribution rate of the map coefficient MC of the map MP having a large appearing region is increased. Thus, even in a case where the virtual viewpoint D moves seamlessly between the maps MP, the resolution of the rendered image is enhanced at high speed and with high accuracy.

Note that in the example of FIG. 8, a case where the number of map coefficients MC involved in the interpolation processing is two is illustrated. However, depending on the direction of the virtual line of sight V, three or more maps MP may be recognized in a field of view. In this case, interpolation processing is performed by utilization of the three or more map coefficients MC. Even in this case, the intermediate coefficient MCt is calculated according to the ratio of the maps MP appearing in the rendered image.

### 2-3. Processing Flow

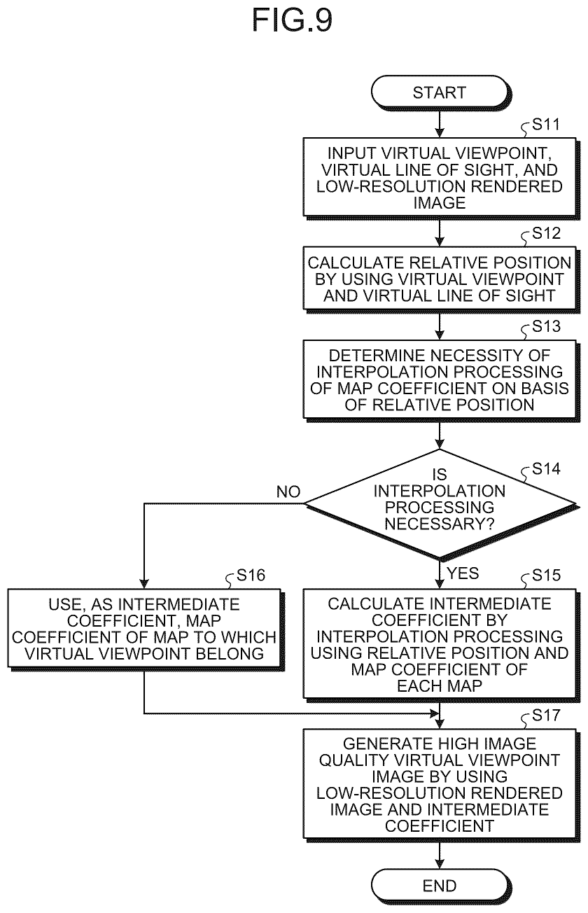

FIG. 9 is a diagram illustrating an example of a processing flow of the rendering system 20.

The user inputs the virtual viewpoint D, the virtual line of sight V, and the low-resolution rendered image RI to the rendering system 20 (Step S11). The relative position calculation unit 21 calculates the relative position α of the plurality of maps MP by using the virtual viewpoint D and the virtual line of sight V (Step S12). The determination unit 23 determines the necessity of the interpolation processing of the map coefficient MC on the basis of the relative position α (Step S13).

In a case where it is determined that the interpolation processing is necessary (Step S14: Yes), the coefficient creation unit 22 calculates the intermediate coefficient MCt by the interpolation processing using the relative position α and the map coefficient MC of each of the maps MP (Step S15). In a case where it is determined that the interpolation processing is unnecessary (Step S14: No), the coefficient creation unit 22 outputs, as the intermediate coefficient MCt, the map coefficient MC of the map MP to which the virtual viewpoint D belongs (Step S16).

After the intermediate coefficient MCt is calculated, the processing unit 24 generates the high image quality virtual viewpoint image VI by using the low-resolution rendered image RI and the intermediate coefficient MCt (Step S17).

### 2-4. Another Example of Rendering

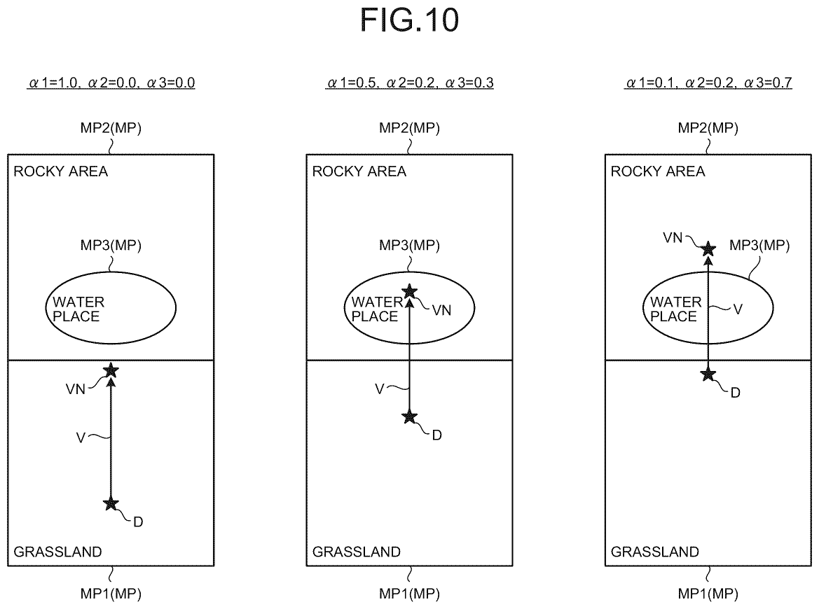

FIG. 10 is a diagram for describing another example of rendering using a plurality of maps MP.

In the example of FIG. 10, a first map MP1 corresponding to a first scene, a second map MP2 corresponding to a second scene, and a third map MP3 corresponding to a third scene are used as the plurality of maps MP. The first scene is a scene of grassland. The second scene is a scene of a rocky area. The third scene is a scene of a water place. The number of map coefficients MC involved in the interpolation processing is three.

In a case where there are three types of maps MP, the relative position calculation unit 21 calculates, for each of the maps MP, a ratio of the map MP appearing in the rendered image. For example, the relative position calculation unit 21 calculates a ratio at which the first map MP1 appears in the rendered image as a first relative position α1. The relative position calculation unit 21 calculates a ratio at which the second map MP2 appears in the rendered image as a second relative position α2. The relative position calculation unit 21 calculates a ratio at which the third map MP3 appears in the rendered image as a third relative position α3.

In an example on a left side of FIG. 10, the entire virtual line of sight V is included in the first map MP1. Thus, α1=1.0 and α2=α3=0. In an example at a center of FIG. 10, the virtual line of sight V straddles the first map MP1, the second map MP2, and the third map MP3 at a ratio of 0.5, 0.2, and 0.3. Thus, α1=0.5, α2=0.2, and α3=0.3. In an example on a right side of FIG. 10, the virtual line of sight V straddles the first map MP1, the second map MP2, and the third map MP3 at a ratio of 0.1, 0.2, and 0.7. Thus, α1=0.1, α2=0.2, and α3=0.7.

The coefficient creation unit 22 calculates the intermediate coefficient MCt by using the first relative position α1, the second relative position α2, the third relative position α3, the first map coefficient MC1, the second map coefficient MC2, and the third map coefficient MC3. The intermediate coefficient Wt is calculated as a value satisfying Wt=α1×W1+α2×W2+α3×W3. Although the number of maps MP is 3 in the example of FIG. 10, the intermediate coefficient MCt is calculated by a similar method even when the number of maps MP is 4 or more.

### 3. HARDWARE CONFIGURATION EXAMPLE

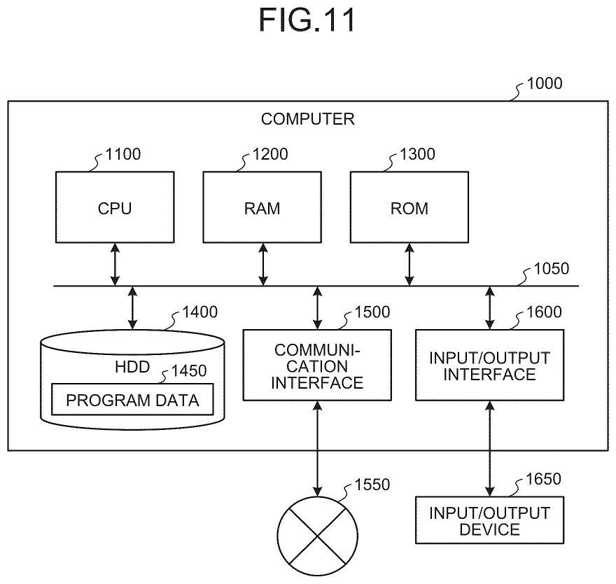

FIG. 11 is a diagram illustrating an example of a hardware configuration of an information processing system 1.

Information processing of the information processing system 1 is realized by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of programs (program data 1450) stored in the ROM 1300 or the HDD 1400, and controls each unit. For example, the CPU 1100 expands the programs, which are stored in the ROM 1300 or the HDD 1400, in the RAM 1200 and executes processing corresponding to the various programs.

The ROM 1300 stores a boot program such as a basic input output system (BIOS) executed by the CPU 1100 during activation of the computer 1000, a program that depends on hardware of the computer 1000, and the like.

The HDD 1400 is a computer-readable non-transitory recording medium that records the programs executed by the CPU 1100, data used by the programs, and the like in a non-transitory manner. Specifically, the HDD 1400 is a recording medium that records an information processing program according to the embodiment as an example of the program data 1450.

The communication interface 1500 is an interface with which the computer 1000 is connected to an external network 1550 (such as the Internet). For example, the CPU 1100 receives data from another equipment or transmits data generated by the CPU 1100 to another equipment via the communication interface 1500.

The input/output interface 1600 is an interface to connect an input/output device 1650 and the computer 1000. For example, the CPU 1100 receives data from an input device such as a keyboard or a mouse via the input/output interface 1600. Furthermore, the CPU 1100 transmits data to an output device such as a display device, speaker, or printer via the input/output interface 1600. Also, the input/output interface 1600 may function as a medium interface that reads a program or the like recorded on a predetermined recording medium (medium). The medium is, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing system 1 according to the embodiment, the CPU 1100 of the computer 1000 realizes a function each of above-described units by executing the information processing program loaded on the RAM 1200. In addition, the HDD 1400 stores the information processing program, various models, and various kinds of data according to the present disclosure. Note that the CPU 1100 reads the program data 1450 from the HDD 1400 and performs execution thereof. However, these programs may be acquired from another device via the external network 1550 in another example.

### 4. EFFECT

The information processing system 1 includes the base coefficient learning unit 12 and the map coefficient learning unit 13. The base coefficient learning unit 12 learns the base coefficient BC by using the plurality of image data sets DS including the first image data set DS1 corresponding to the first scene and the second image data set DS2 corresponding to the second scene. The map coefficient learning unit 13 acquires the first map coefficient MC1 corresponding to the first scene by the transfer learning of transferring the base coefficient BC on the basis of the first image data set DS1. The map coefficient learning unit 13 acquires the second map coefficient MC2 corresponding to the second scene by the transfer learning of transferring the base coefficient BC on the basis of the second image data set DS2. In the information processing method of the present disclosure, processing of the information processing system 1 is executed by the computer 1000. A computer-readable non-transitory storage medium of the present disclosure stores a program for causing the computer 1000 to realize the processing of the information processing system 1.

According to this configuration, both the first map coefficient MC1 and the second map coefficient MC2 are acquired on the basis of the transfer learning obtained by diverting of the learning result of the same base coefficient BC. Thus, a large deviation is not generated between the two learned map coefficients MC. Even when the coefficients obtained by the interpolation processing are used, appropriate image processing is performed. Thus, seamless image processing between the maps MP is realized.

The information processing system 1 includes the relative position calculation unit 21, the coefficient creation unit 22, and the processing unit 24. The relative position calculation unit 21 calculates the relative position α between the first map MP1 corresponding to the first scene and the second map MP2 corresponding to the second scene. The coefficient creation unit 22 calculates the intermediate coefficient MCt between the first map coefficient MC1 and the second map coefficient MC2 by the interpolation processing based on the relative position α. The processing unit 24 performs the image processing using the intermediate coefficient MCt.

According to this configuration, the interpolation processing is performed in consideration of a relative positional relationship between the maps MP. Thus, an appropriate coefficient can be obtained.

The relative position calculation unit 21 calculates ratios of the first map MP1 and the second map MP2 appearing in the video viewed from the virtual viewpoint D as the relative position α. For example, the relative position α is calculated on the basis of the distance from the virtual viewpoint D to the boundary BW between the first map MP1 and the second map MP2 and the distance from the virtual viewpoint D to the vanishing point VN. When the distance to the boundary BW is P, the distance to the vanishing point VN is Q, and the relative position is α, α=P/Q is satisfied, for example.

According to this configuration, the contribution (interpolation coefficients) of the individual map coefficients MC is appropriately set.

The information processing system 1 includes the determination unit 23. The determination unit 23 determines necessity of the interpolation processing on the basis of the relative position α.

According to this configuration, an operation load is reduced by omission of the unnecessary interpolation processing.

The map coefficient learning unit 13 changes the intermediate layer close to the output layer greatly compared to the intermediate layer close to the input layer by the transfer learning.

According to this configuration, a coefficient value in the vicinity of the output layer responsible for extraction of high-order features such as a shape and a texture is greatly changed. Thus, appropriate image processing adapted to a change in a scene is performed.

Note that the effects described in the present description are merely examples and are not limitations, and there may be another effect.

### 5. MODIFICATION EXAMPLE

In the above-described embodiment, an example in which a scene and a map MP (map coefficient MC) correspond to each other on a one-to-one basis has been described. However, a plurality of maps MP (map coefficients MC) may be associated with one scene. In this case, a plurality of base coefficients BC (base coefficient group) may be generated.

### Supplementary Note

Note that the present technology can also have the following configurations.
(1)

An information processing system comprising:
a base coefficient learning unit that performs learning of a base coefficient by using a plurality of image data sets including a first image data set corresponding to a first scene and a second image data set corresponding to a second scene; and
a map coefficient learning unit that acquires a first map coefficient corresponding to the first scene by transfer learning of transferring the base coefficient on a basis of the first image data set and acquires a second map coefficient corresponding to the second scene by transfer learning of transferring the base coefficient on a basis of the second image data set.
(2)

The information processing system according to (1), further comprising
a relative position calculation unit that calculates a relative position between a first map corresponding to the first scene and a second map corresponding to the second scene,
a coefficient creation unit that calculates an intermediate coefficient between the first map coefficient and the second map coefficient by interpolation processing based on the relative position, and
a processing unit that performs image processing using the intermediate coefficient.
(3)

The information processing system according to (2), wherein
the relative position calculation unit calculates, as the relative position, ratios of the first map and the second map appearing in a video viewed from a virtual viewpoint.
(4)

The information processing system according to (3), wherein
the relative position is calculated on a basis of a distance from the virtual viewpoint to a boundary between the first map and the second map, and a distance from the virtual viewpoint to a vanishing point.
(5)

The information processing system according to (4), wherein
when the distance to the boundary is P, the distance to the vanishing point is Q, and the relative position is α, α=P/Q is satisfied.
(6)

The information processing system according to any one of (2) to (5), further comprising
a determination unit that determines necessity of the interpolation processing on a basis of the relative position.
(7)

The information processing system according to any one of (1) to (6), wherein
the map coefficient learning unit changes an intermediate layer close to an output layer greatly compared to an intermediate layer close to an input layer by the transfer learning.
(8)

An information processing method executed by a computer, the information processing method comprising:
learning a base coefficient by using a plurality of image data sets including a first image data set corresponding to a first scene and a second image data set corresponding to a second scene;
acquiring a first map coefficient corresponding to the first scene by transfer learning of transferring the base coefficient on a basis of the first image data set; and
acquiring a second map coefficient corresponding to the second scene by transfer learning of transferring the base coefficient on a basis of the second image data set.
(9)

A computer-readable non-transitory storage medium storing a program causing a computer to realize
learning a base coefficient by using a plurality of image data sets including a first image data set corresponding to a first scene and a second image data set corresponding to a second scene,
acquiring a first map coefficient corresponding to the first scene by transfer learning of transferring the base coefficient on a basis of the first image data set, and
acquiring a second map coefficient corresponding to the second scene by transfer learning of transferring the base coefficient on a basis of the second image data set.

### REFERENCE SIGNS LIST

1 INFORMATION PROCESSING SYSTEM
12 BASE COEFFICIENT LEARNING UNIT
13 MAP COEFFICIENT LEARNING UNIT
21 RELATIVE POSITION CALCULATION UNIT
22 COEFFICIENT CREATION UNIT
23 DETERMINATION UNIT
24 PROCESSING UNIT
1400 COMPUTER-READABLE NON-TRANSITORY RECORDING MEDIUM (HDD)
α RELATIVE POSITION
BC BASE COEFFICIENT
BW BOUNDARY
D VIRTUAL VIEWPOINT
DS IMAGE DATA SET
DS1 FIRST IMAGE DATA SET
DS2 SECOND IMAGE DATA SET
MC MAP COEFFICIENT
MC1 FIRST MAP COEFFICIENT
MC2 SECOND MAP COEFFICIENT
MCt INTERMEDIATE COEFFICIENT
MP1 FIRST MAP
MP2 SECOND MAP
VN VANISHING POINT

1. An information processing system comprising:
a base coefficient learning unit that performs learning of a base coefficient by using a plurality of image data sets including a first image data set corresponding to a first scene and a second image data set corresponding to a second scene; and
a map coefficient learning unit that acquires a first map coefficient corresponding to the first scene by transfer learning of transferring the base coefficient on a basis of the first image data set and acquires a second map coefficient corresponding to the second scene by transfer learning of transferring the base coefficient on a basis of the second image data set.

2. The information processing system according to claim 1, further comprising
a relative position calculation unit that calculates a relative position between a first map corresponding to the first scene and a second map corresponding to the second scene,
a coefficient creation unit that calculates an intermediate coefficient between the first map coefficient and the second map coefficient by interpolation processing based on the relative position, and
a processing unit that performs image processing using the intermediate coefficient.

3. The information processing system according to claim 2, wherein
the relative position calculation unit calculates, as the relative position, ratios of the first map and the second map appearing in a video viewed from a virtual viewpoint.

4. The information processing system according to claim 3, wherein
the relative position is calculated on a basis of a distance from the virtual viewpoint to a boundary between the first map and the second map, and a distance from the virtual viewpoint to a vanishing point.

5. The information processing system according to claim 4, wherein
when the distance to the boundary is P, the distance to the vanishing point is Q, and the relative position is α, α=P/Q is satisfied.

6. The information processing system according to claim 2, further comprising
a determination unit that determines necessity of the interpolation processing on a basis of the relative position.

7. The information processing system according to claim 1, wherein
the map coefficient learning unit changes an intermediate layer close to an output layer greatly compared to an intermediate layer close to an input layer by the transfer learning.

8. An information processing method executed by a computer, the information processing method comprising:
learning a base coefficient by using a plurality of image data sets including a first image data set corresponding to a first scene and a second image data set corresponding to a second scene;
acquiring a first map coefficient corresponding to the first scene by transfer learning of transferring the base coefficient on a basis of the first image data set; and
acquiring a second map coefficient corresponding to the second scene by transfer learning of transferring the base coefficient on a basis of the second image data set.

9. A computer-readable non-transitory storage medium storing a program causing a computer to realize
learning a base coefficient by using a plurality of image data sets including a first image data set corresponding to a first scene and a second image data set corresponding to a second scene,
acquiring a first map coefficient corresponding to the first scene by transfer learning of transferring the base coefficient on a basis of the first image data set, and
acquiring a second map coefficient corresponding to the second scene by transfer learning of transferring the base coefficient on a basis of the second image data set.
